(19) United States
(12) Patent Application Publication
(10) Pub. No.: US 2005/0226538 A1
(43) Pub. Date: Oct. 13, 2005

(54) Video scaling

(76) Inventors: Riccardo Di Federico, Monza (IT); Mario Raffin, Pordenone (IT); Paola Carrai, Monza (IT); Giovanni Ramponi, Trieste (IT)

Correspondence Address: PHILIPS INTELLECTUAL PROPERTY & STANDARDS, P.O. BOX 3001, BRIARCLIFF MANOR, NY, 10510, US

(21) Appl. No.: 10/516,157

(22) PCT Filed: May 21, 2003
(86) PCT No.: PCT/IB03/02199

§ 371 Date: Nov. 30, 2004

(30) Foreign Application Priority Data
Jun. 3, 2002 (EP) 02077169.7

(51) Int. Cl. G06T 3/40

(52) U.S. Cl. 382/299; 345/660; 382/300

(57) ABSTRACT

A method of converting an input video signal (IV) with an input resolution into an output video signal (OV) with anoutput resolution comprises the steps of labeling (10) input pixels of the input video signal (IV) being text as input text pixels to obtain an input pixel map (IPM) indicating which input pixel is an input text pixel, and scaling (11) the input video signal (IV) to supply the output video signal (OV), wherein the scaling (11) is dependent on whether the input pixel is labeled as input text pixel.

The invention relates to a method of converting an input video signal with an input resolution into an output video signal with an output resolution. The invention further relates to a converter for converting an input video signal with an input resolution into an output video signal with an output resolution, a display apparatus with such a converter and a video signal generator with such a converter.

Traditional analog displays, like CRTs, are seamlessly connectable to many different video/graphic sources with several spatial resolutions and refresh rates. By suitably controlling the electron beam it is possible to address any arbitrary position on the screen, thus making it possible to scale the incoming image by exactly controlling the inter pixel distance in an analog way.

When dealing with matrix displays which have a fixed resolution, such as liquid crystal displays (LCD), Plasma Display Panels (PDP), and Polymer LED (PolyLed), a converter is required to digitally scale the incoming image in order to adapt its resolution to the fixed display resolution. This digital scaling operation is generally performed by means of a digital interpolator which uses a linear interpolation scheme and which is embedded in the display apparatus (further referred to as monitor).

However, traditional linear interpolation schemes introduce degradation in the displayed picture, particularly visible either as blurring or staircase effect/geometrical distortions. Graphic content, and especially text, is very sensitive to the artifacts caused by linear interpolation techniques.

It is an object of the invention to improve the readability and appearance of the scaled text.

A first aspect of the invention provides a method of converting an input video signal with an input resolution into an output video signal with an output resolution as claimed in claim 1. A second aspect of the invention provides a converter as claimed in claim 17. A third aspect of the invention provides a display apparatus as claimed in claim 18. A fourth aspect of the invention provides a video signal generator as claimed in claim 19. Advantageous embodiments are defined in the dependent claims.

The prior art interpolation algorithms are required in matrix displays which have a fixed matrix of display pixels. These algorithms adapt the input video signal to the graphic format of the matrix of display pixels in order to define the values of all the output display pixels to be displayed on the matrix of display pixels.

Interpolation techniques usually employed for this purpose consist of linear methods (e.g. cubic convolution or box kernels). These prior art methods have two main drawbacks.

Firstly, the whole image is interpolated with the same kernel, which is a suboptimal processing. Different contents are sensitive to different interpolation artifacts. For example, very sharp interpolation kernels may be suitable for preserving graphic edges but are likely to introduce pixilation in natural areas.

Secondly, even in the specific case of text, linear kernels cannot achieve a good compromise between blurring and geometrical distortions. On the one hand, box interpolation produces perfectly sharp edges but irregularly shaped characters, while on the other hand, the cubic spline filter preserves the general appearance of the character but introduces blurring.

A converter in accordance with the invention comprises a scaler and a text detector which produces a binary output which indicates whether an input pixel is text or non-text. In other words, the text detector labels the input pixels of the input video as text or non-text (also referred to as background). The scaler scales the input video signal to obtain the output video signal, wherein the scaling operation is different for text and non-text input pixels. This allows optimizing the scaling depending on the kind of input video signal detected.

In an embodiment as defined in claim 2, the binary input text map comprising the labeled input pixels is mapped to the output domain as an output text map wherein the output pixels are labeled as text or background. To illustrate the output map, in a simple embodiment, the output map is a scaled input map. The output text map forms the ‘skeleton’ of the interpolated text. Both the input map and the output map may be virtual, or may be stored (partly) in a memory. An input pixel of the input map which is labeled as text information is referred to as input text pixel, and an output pixel of the output map which is labeled as text information is referred to as output text pixel.

The scaling operation is controlled by the output map.

The labeling of a particular output pixel as text pixel depends on the position of the corresponding input text pixel as defined by the scaling factor, and is based on the position and the morphology (neighborhood configuration) of the input text pixels. This has the advantage that not only the fact whether a pixel is text is taken into account in the scaling but also the geometrical pattern formed by the input text pixel and at least one of its surrounding input text pixels. Vertical and horizontal parts of text can be recognized and can be treated different by the scaler than diagonal or curved parts of the text. Preferably, the vertical and horizontal parts of text should be kept sharp (no, or only a very mild interpolation which uses information of surrounding non-text pixels), the diagonal or curved parts of the text may be softened to minimize staircase effects (more interpolation to obtain gray levels around these parts).

In an embodiment as defined in claim 3, the labeling depends on whether in the input map a connected diagonal text pixel is detected. If yes, the corresponding output pixels are positioned in the output map such that they still interconnect. In this way, in the output map the geometry of the character is kept intact as much as possible.

In an embodiment as defined in claim 4, the labeling depends on whether in the input map a connected vertical aligned text pixel is detected. If yes, the corresponding output pixels are positioned in the output map such that they are vertically aligned again. In this way, in the output map the geometry of the character is kept intact as much as possible.

In an embodiment as defined in claim 5, the labeling of the output pixels in the output map is calculated as the length of the line of successive input text pixels multiplied by the scaling factor. In this way the length of the corresponding line of successive output text pixels in the output map is appropriately scaled.

In an embodiment as defined in claim 6, it is possible to select a rounding of the length of the corresponding line of successive output text pixels to the integer most appropriate by selecting a value of the factor k.

In an embodiment as defined in claim 7, if a diagonal connection is detected, this prevails over a vertical alignment. This appeared to produce the best results in keeping the shape of the scaled characters as close to the shape of the input characters.

In an embodiment as defined in claim 8, the geometrical structure formed by an end of a line pixel with adjacent pixels is used to determine where in the output map the text output pixel is positioned. In this way the geometry of the scaled character in the output map resembles the geometry of the original character in the input map best.

In an embodiment as defined in claim 9, the scaled line of adjacent text labeled output pixels which is the converted line of adjacent text labeled input pixels, depends on whether the start or end points of the line of output pixels are fixed by the preservation of a diagonal connection or a vertical alignment. If so, the position in the output map of such a start or end point is fixed. The algorithms are defined which determine the not yet fixed start or end points. This prevents disconnections or misalignment of output text pixels.

In an embodiment as defined in claim 10, an algorithm is defined which determines the not yet fixed start and end points of a line.

In an embodiment as defined in claim 11, the output pixels in the output map which are labeled as text pixels are replaced by the text information (color and brightness) of the corresponding input text pixels. In this way the text information is not interpolated and thus perfectly sharp, however no rounding of characters is obtained. The non-text input video may be interpolated or may also be replaced based on the output map.

In an embodiment as defined in claim 12, the scaling interpolates a value of an output video sample based on a fractional position between (or, the phase of the output video sample with respect to the) adjacent input video samples, and adapts the fractional position (shifts the phase) based on whether a predetermined output pixel corresponding to the output video sample is text or not. For example, the interpolator may be a known Warped Distance Interpolator (further referred to as WaDi) which has an input for controlling the fractional position. A proper control of the WaDi allows the text to be less interpolated than non text information, preserving the sharpness of the text.

In an embodiment as defined in claim 13, the adapting of the fractional position is further based on a pattern formed by output text pixels surrounding the predetermined output pixel. Now, the WaDi is controlled by the local morphology of input and output text maps, and is able to produce either step or gradual transitions to provide proper luminance profiles for different parts of the characters. In particular, the main horizontal and vertical strokes are kept sharp, while diagonal and curved parts are smoothed.

In an embodiment as defined in claim 14, the calculations required to adapt the fractional portion are only performed for transition output pixels involved in a transition from non-text to text. This minimizes the computing power required.

In an embodiment as defined in claim 15, the fractional portion is adapted (the amount of shift is determined) dependent on both whether the transition output pixels is labeled as text or non-text, and on the pattern of output text pixels surrounding the transition output pixel.

In an embodiment as defined in claim 16, the scaling comprises a user controllable input for controlling an amount of the adapting of the fractional portion for all pixels. In this manner, the general anti-aliasing effect can be controlled by the user from a perfectly sharp result to a classical linearly interpolated image.

These and other aspects of the invention are apparent from and will be elucidated with reference to the embodiments described hereinafter.

### BRIEF DESCRIPTION OF THE DRAWINGS

In the drawings:

FIG. 1 show some examples of prior art interpolation schemes,

FIG. 2 show corresponding reconstructed signals,

FIG. 3 shows an original text image at the left hand side, and an image interpolated with a cubic kernel at the right hand side,

FIG. 4 shows an original text image at the left hand side, and an image interpolated with a box kernel at the right hand side,

FIG. 5 shows a general scheme of a computer monitor in accordance with an embodiment of the invention,

FIG. 6 shows an embodiment of the scaling engine,

FIG. 7 shows a block diagram of an embodiment of a scaler,

FIG. 8 shows a flowchart of an embodiment of the output text map construction in accordance with the invention,

FIGS. 9A and 9B show examples of disconnected or misaligned text pixels in the scaled character,

FIG. 10 shows various diagonal connections and vertical alignment patterns,

FIG. 11 shows a flowchart of an embodiment of the output text map construction in accordance with the invention,

FIG. 12 shows a waveform for elucidating the known Warped Distance (WaDi) concept,

FIG. 13 shows a flowchart elucidating the operation of the WaDi controller in accordance with an embodiment of the invention,

FIG. 14 shows from top to bottom, a scaled text obtained with a cubic interpolation, an embodiment in accordance with the invention, and the nearest neighbor interpolation, and

FIG. 15 shows a block diagram of a video signal generator with a scaler in accordance with the invention.

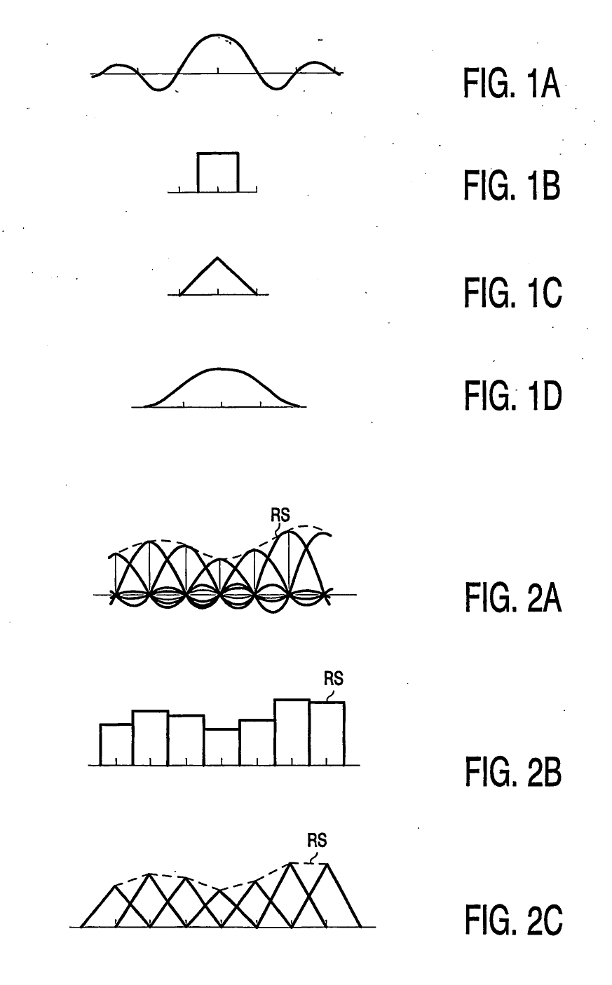

FIG. 1 show some examples of prior art interpolation schemes. FIG. 1A shows a Sync function, FIG. 1B a Square function, FIG. 1C a Triangle function, FIG. 1D a cubic spline function.

FIG. 2 show corresponding reconstructed signals RS, FIG. 2A based on the Sync function, FIG. 2B based on the Square function, and FIG. 2C based on the Triangle or Ramp function.

Commonly employed image rescaling applications are traditional digital interpolation techniques based on linear schemes. The interpolation process conceptually involves two domain transformations. The first transformation goes from the original discrete domain to the continuous (real) domain by means of a kernel function Hin (not shown). The second transformation Hout is obtained by sampling the output of the first transformation Hin and supplies output samples in the final discrete domain. In order to avoid aliasing, the second down-sampling Hout must be done on a signal that has been low pass filtered in such a way that its bandwidth is limited to the smallest one of the two Nyquist frequencies of the input and the output domain. This low pass filtering is performed by Hout. Practical implementations make use of a single filter which results from the convolution of Hin and Hout.

Commonly employed filter kernels as shown in FIGS. 1B to 1D have a substantially limited bandwidth. If the bandwidth is limited, aliasing will not occur, but blurring is introduced which is particularly evident around graphic edges.

As graphic patterns usually have a non-limited bandwidth, they cannot be correctly represented in any discrete domain. However step-like transitions, typical of some graphic patterns such as text, can be scaled by using kernels with non limited bandwidth such as the box (also known as square, nearest neighbor or pixel repetition). On the other hand, the box kernel introduces aliasing which, from a spatial point of view, turns into geometrical distortions.

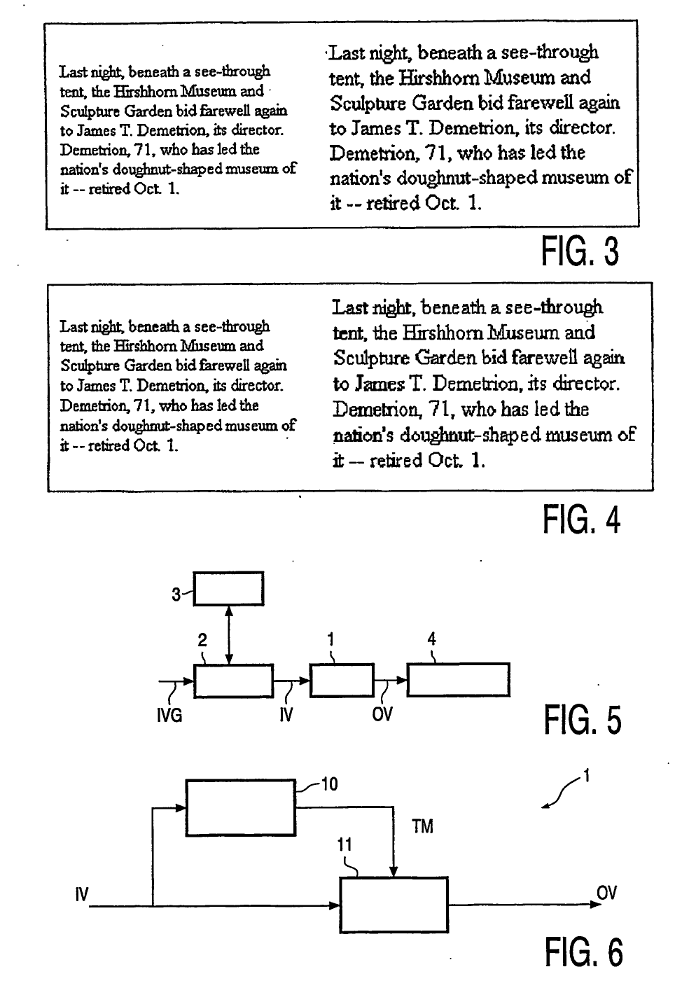

FIG. 3 shows an original text image at the left hand side which is interpolated with a cubic kernel. As is visible in the right hand image, blurring is introduced.

FIG. 4 shows an original text image at the left hand side which is interpolated with a box kernel which, as is visible in the right hand image, leads to geometrical distortions.

As becomes clear from FIGS. 3 and 4, the basic problem is that whichever linear kernel is selected, or blurring or geometrical distortion is introduced in graphic patterns. The scaling is very critical for text of which the size is small (up to 14 pixels) and for up-scale factors which are small (between 1 and 2.5). This is caused by the fact that a positioning error of one pixel only in the output domain results in a big relative error compared to the output character size. For example, if the output character size is 6 pixels, the equivalent distortion may be about 20%. However, most of the text commonly present in computer applications is in the above range and practically all interesting scale factors for format conversion are in the range 1 to 2.5.

The invention is directed to a method detecting whether a pixel is text or not and adapting the interpolation dependent on this detection.

In an embodiment in accordance with the invention, the sharpness is maximized while the regularity of the text character is preserved as much as possible, by first mapping text pixels to the output domain with a modified nearest neighbor scheme, and then applying a non linear interpolation kernel which smoothes some character details.

The known nearest neighbor scheme introduces geometrical distortions because it implements a rigid mapping between input and output domain pixels with no distinction between different contents. As an example, the same pattern (for example a character) is scaled differently depending on its location on the input grid, since the nearest neighbor processing just takes into account the relative input and output grid positioning, not the fact that a certain pixel belongs to a particular structure or content. This consideration applies to an linear kernels, even if band limited kernels are applied which somewhat ‘hide’ the effect of the changing position by locally smoothing edges.

Therefore, the method in accordance with the invention provides a content dependent processing that provides appropriate handling for text and non text pixels.

A general approach to text scaling could be the recognition of all single characters, including font type and size (for example, by means of an OCR—optical character recognition-procedure) and then rebuild the newly scaled character by re-rendering its vector representation (the way an operating system would scale characters). However, this approach would require a large computational power. This might be a problem if the computations have to be performed in real-time display processing. In addition, the re-rendering would lack generality since it would be practically impossible storing and recognizing all possible font types.

Even though we may not rely on a full vectorial description of the characters we are still able to use text rendering related techniques and morphological constraints in order to preserve some general text properties to keep the vertical and horizontal strokes sharp and their thickness strictly fixed. Diagonal and curved parts may be smoothed by additional gray levels (anti-aliasing effect). The scaling process should not cause character inner misalignment, i.e. the grid fitting must be uniform for all parts of a character.

The algorithm in accordance with an embodiment of the invention can be used whenever a source image which contains text and which has a predetermined resolution has to be adapted to a different resolution. A practical example of an application is an integrated circuit controller for fixed matrix displays. The role of the controller is to adapt the resolution of the source video (typically the output of a PC graphic adapter) to the resolution of the display. Besides adapting the image size, this adaptation is necessary in order to match all physical and technical characteristics of the display, such as native size, refresh rate progressive/interlaced scan, gamma etc.

FIG. 5 shows a general scheme of a computer monitor in accordance with an embodiment of the invention. A frame rate converter 2 which is coupled to a frame memory 3 receives a video signal IVG and supplies input video IV to a scaling engine 1. The frame rate of the video signal IVG is converted into a frame rate of the input video IV suitable for display on the matrix display 4. The scaling engine 1 scales the input video IV to obtain an output video OV such that the resolution of the output video OV which is supplied to the matrix display 4 matches the resolution of the matrix display 4 independent of the resolution of the input video IV. The video signal WVG is supplied by a graphics adapter of a computer. It is also possible to provide the frame rate converter 2 and the scaling engine 1 of FIG. 5 in the computer PC as is shown in FIG. 15.

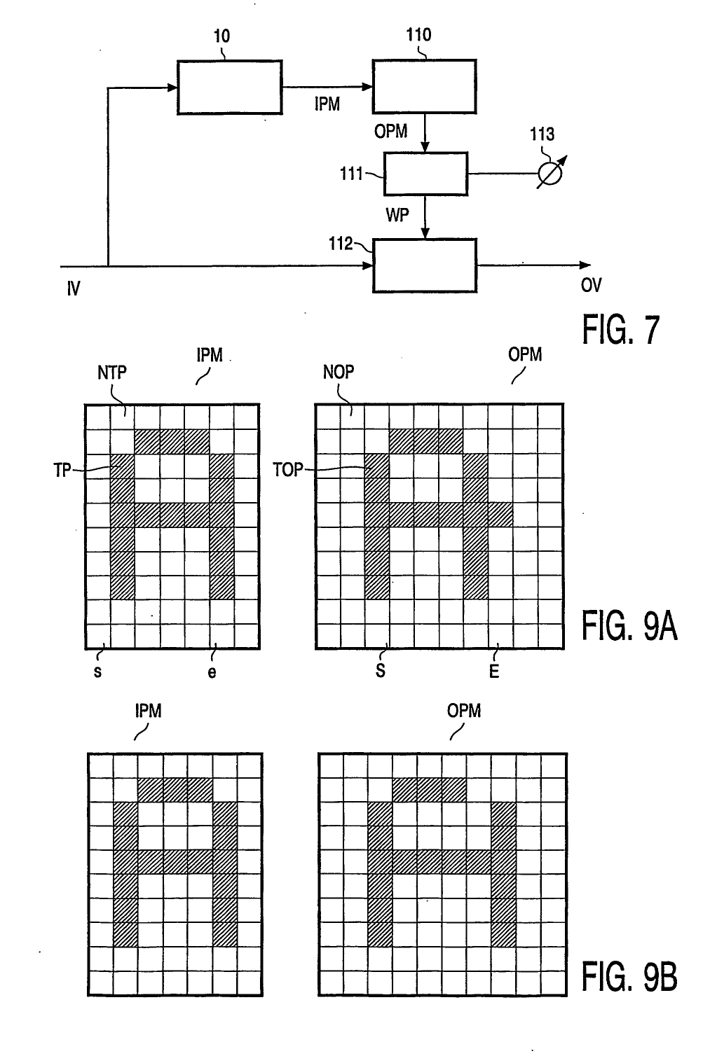

FIG. 6 shows an embodiment of the scaling engine. The scaling engine 1 comprises a text detector 10 and a scaler 11 which performs a scaling algorithm. The text detector 10 receives the input video IV and supplies information TM to the scaler 11 which indicates which input video samples in the input video IV are text and which not. The scaler 11 which performs a scaling algorithm receives the input video IV and supplies the output video OV which is the scaled input video IV. The scaling algorithm is controlled by the information TM to adapt the scaling dependent on whether the input video samples are text or not.

FIG. 7 shows a block diagram of an embodiment of a converter which performs a scaling algorithm. The converter comprises the text detector 10, an output text map constructor 110, an adaptive warper 111, an interpolator 112, and a global sharpness control 113.

The interpolator 112 interpolates the input video signal IV (representing the input video image) which comprises input video samples to obtain the output video signal OV (representing the output video image) which comprises output video samples. The interpolator 112 has a control input to receive a warped phase information WP which indicates how to calculate the value of an output video sample based on the values of (for example, the two) surrounding input video samples. The warped phase information WP determines the fractional position between the two input video samples at which the value of the output video sample has to be calculated. The value calculated depends on the interpolation algorithm or function used. The interpolation algorithm determines the function between two input samples which determines on every position between the two samples the value of the output sample. The position between the two samples is determined by the phase information WP.

The text detector 10 receives the input video signal IV to generate the input pixel map IPM in which is indicated which input video samples are text. The output text map constructor 110 receives the input pixel map IPM to supply the output pixel map OPM. The output pixel map OPM is a map in which for the output video samples is indicated whether the output video sample is to be considered to be text or not. The output pixel map OPM is constructed from the input pixel map IPM such that the geometrical properties of scaled characters in the output video signal OV is kept as close as possible to the original geometrical properties of the input characters in the input video signal IV. The construction of the output pixel map OPM is based on the scaling factor, and may be based on morphological constraints.

The adaptive warper 111 determines the warped phase information (the fractional position) dependent on the output pixel map OPM. The user adjustable global sharpness control 113 controls the amount of warping over the whole picture.

In a preferred embodiment, the algorithm is performed by a display IC controller. Because of the real-time processing of the input video IV into the output video OV, the number and complexity of computations and the memory resources are preferably limited. In particular, per pixel computations must be reduced. Another limitation concerning computations is related to the fact that floating point operations are often too complex to be implemented in hardware. Therefore, preferably, only logic and at most integer operations will be used. As far as memory is concerned, it is in principle possible to design an algorithm that freely uses a complete frame buffer (which stores the whole incoming image), but often, scaling algorithms are performed at the end of the processing chain, and access to an external frame buffer is not simple. In this case the scaler can only access its internal memory. As memory tends to occupy a large chip area, preferably only a few lines around the line to be processed are buffered in the memory. However, the scaling algorithm works either with a full frame memory or with a limited number of buffered lines.

The scaling algorithm is intended for magnification, i.e. scaling factors greater than one, particularly in the range 1 to 2.5, which includes all typical graphic format conversion factors for computer video supplied by the graphic adapter.

The scaling algorithm is content driven, the text detection is required to allow a specialized processing, wherein text pixels are treated differently than background pixels. The algorithm preferably involves two main steps. Firstly, the output text map is constructed and secondly, an adaptive interpolation is performed. The last step is not essential but further improves the quality of the displayed text.

The mapping step 110 reconstructs the input binary pixel map IPM (pixels detected by the text detection) to the output domain. This operation is binary, meaning that output pixels are labeled as text or background, based on the position and morphology (neighborhood configuration) of the input text pixels.

The adaptive interpolator 112 performs an anti-aliasing operation which is performed once the output text ‘skeleton’ has been built, in order to generate some gray level pixels around characters. Even though the original text was sharp (i.e. with no anti-aliasing gray levels around), it is appropriate to generate some gray levels in the processed image, as this, if correctly done, helps in reducing the jaggedness and geometrical distortions. The amount of smoothing gray levels can be adjusted in such a way that different part of characters will be dealt with differently.

Before describing the algorithm in more detail, it should be noted that the steps in horizontal and vertical direction are the same after an image transpose operation is performed Conceptually, the whole scaling may involve the following steps:
perform (horizontal) scaling,
transpose the horizontally scaled text map and the horizontally scaled image,
perform (horizontal) scaling, and
transpose the final result.

Consequently, only the horizontal scaling is described in the now following.

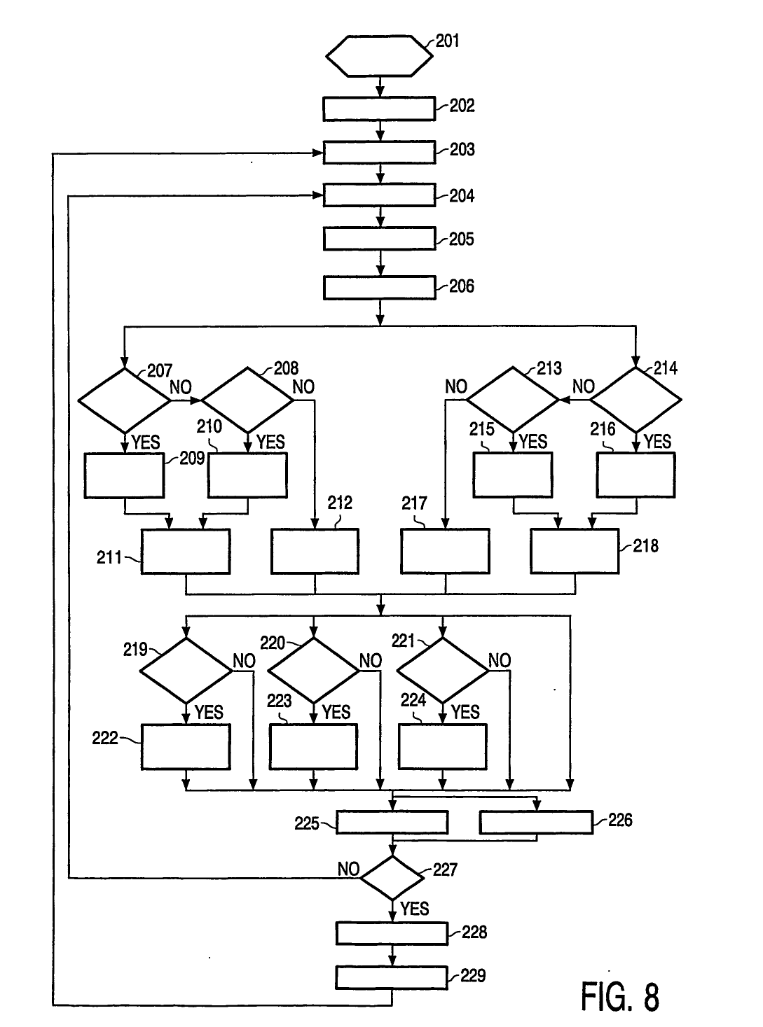

FIG. 8 shows a flowchart of an embodiment of the output text map construction in accordance with the invention.

FIGS. 9A and 9B show examples of disconnected or misaligned text pixels in the scaled character. The character shown at the left hand side is the input character in the input pixel map IPM. The position in the input pixel map IPM of the left hand vertical stroke of the character is denoted by s, the position of the right hand vertical stroke is denoted by e. Thus, the starting pixel of the lower horizontal line starts at the start pixel position s en ends at the end pixel position e. The positions in the input pixel map IPM are denoted by TP for a pixel labeled as text and by NTP for a pixel not labeled as text. The character shown at the right hand side is the output character in the output pixel map OPM. The position in the output pixel map OPM of the left hand vertical stroke of the character is denoted by S which corresponds to the scaled position of the position s in the input pixel map IPM, the position of the right hand vertical stroke is denoted by E. Thus, the starting pixel of the lower horizontal line starts at the start pixel position S and ends at the end pixel position E. The positions in the output pixel map OPM are denoted by TOP for a pixel labeled as text and by NOP for a pixel not labeled as non-text or background.

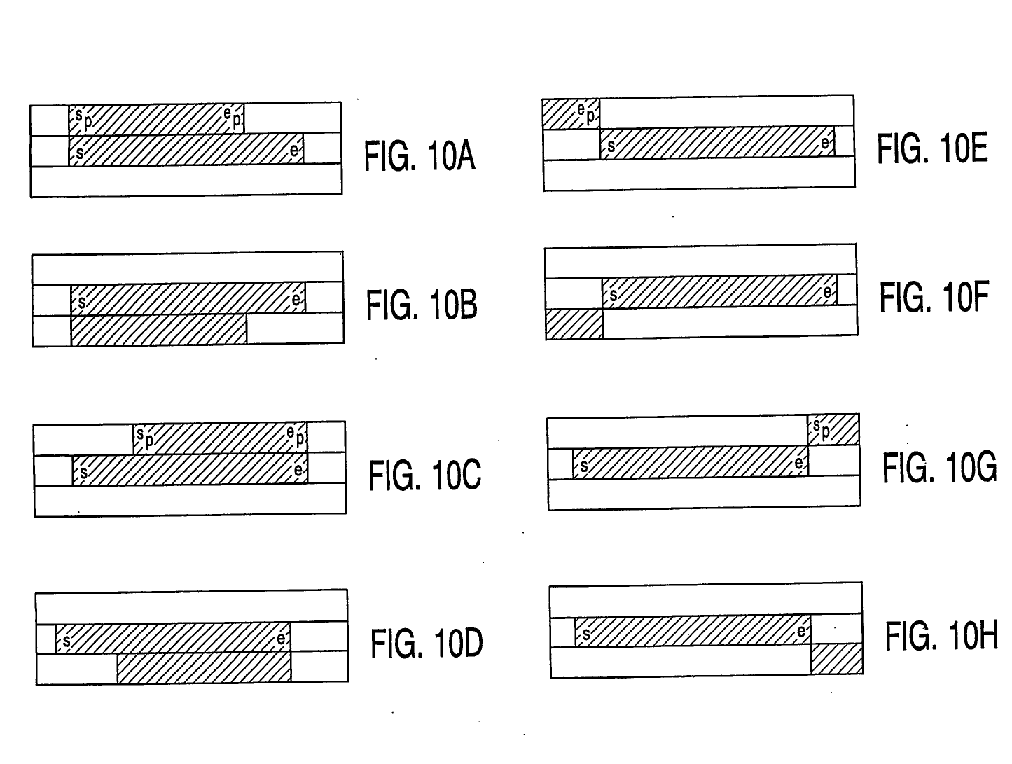

FIG. 10 show various diagonal connections and vertical alignment patterns, both toward the previous line and to the next line, distinguishable with a three line high analysis window. In the input pixel map IPM, in a predetermined video line, the start of a sequence of text pixels is denoted by s, and its end as e. In the previous video line, the start and the end of a sequence are indicated by sp and ep, respectively. Although not shown, in the output pixel map OPM, in the predetermined video line, the start and end of a sequence associated with the input sequence determined by s and e are denoted by S and A, respectively. And in the previous video line, the start and end of a sequence associated with the input sequence determined by sp and ep are denoted by Sp and Ep.

In FIG. 8, the input to output mapping of text pixels starts from a text detection step 202 on the input image 201. A possible detection algorithm used for the examples included in this document is described in attorneys docket PHIT020011EPP. It has to be noted that the text detection 202 is pixel-based and binary, meaning that each single pixel is assigned a binary label indicating whether or not it is text.

Aim of the complete text mapping algorithm is to create a binary output pixel map OPM which is the scaled binary input pixel map WM which comprises the text pixels found in the input image 201. The resulting output pixel map OPM constitutes the ‘skeleton’ of the scaled text, around which some other gray levels may be generated. For this reason the mapping must preserve, as much as possible, the original text appearance, especially in terms of geometrical regularity.

The simplest way to obtain a binary map by scaling another binary map is to apply the nearest neighbor scheme, which associates to each output pixel the nearest one in the input domain. If z is the scale factor, I is the current output pixel index, and i is the associated input pixel index, the nearest neighbor relation is:
i=round(I/z) (1)
In the output pixel map OPM, the value of an output pixel is the value of the nearest input pixel. Since the input domain is less dense than the output domain, a predetermined number of input pixel values have to be associated to a higher number of output pixels. Consequently, the value of the same input text pixel may be used for one or two consecutive output pixels depending on the shift in instants of occurring of the input pixels and the corresponding output pixel. This variability in the instants of occurrence of output pixels with respect to the instants of occurrence of the input pixels results in a variable thickness and distortion of the shape of characters.

The reason why the nearest neighbor scheme produces irregularly shaped characters is that it makes no distinction between text and background pixels. The decision of labeling an output pixel as text or background (white or black in the sample images) is taken only on the basis of the label of the nearest input pixel. Since text detection adds the information of being text or background to each input pixel, it is possible to apply specific constraints for preserving some expected text characteristics. One of them is thickness regularity.

The basic constraint we add to the pixel repetition scheme is that any contiguous sequence of text pixels of length l in the input domain IPM must be mapped to a sequence in the output domain OPM with fixed length L. Ideally, for each possible input sequence length l it is possible to select an arbitrary value for the corresponding output sequence length L. In practice, the output sequence length L is determined by approximating to an integer the product 1*z where z is the scale factor. The integer approximation could be performed in the following manner:

| Operation | Symbol | Description |
|---|---|---|
| floor(x) | └x┘ | approximate to the nearest |
| | | integer toward 0 |
| ceil(x) | ┌x┐ | approximate to the nearest |
| | | integer toward infinity |
| round(x) | <x> | approximate to the nearest |
| | | integer |

or, more general, by the parametric rounding operation:
roundₖ(x)=└x+k┘ (2)
wherein 1-k is the value of the fractional part of x above which x is rounded to the nearest higher integer. The usual floor, ceil and round operation are obtained as particular cases when k is 0, 0.5 and 1, respectively. Given a scaling factor z, the choice of k influences the relation between input and output thickness. In fact, the higher k is, the thicker the scaled text is, because the roundₖ operation tends to behave like the ceil operation. The relation between input and output sequence length is then:
L=roundₖ(l·z) (3)

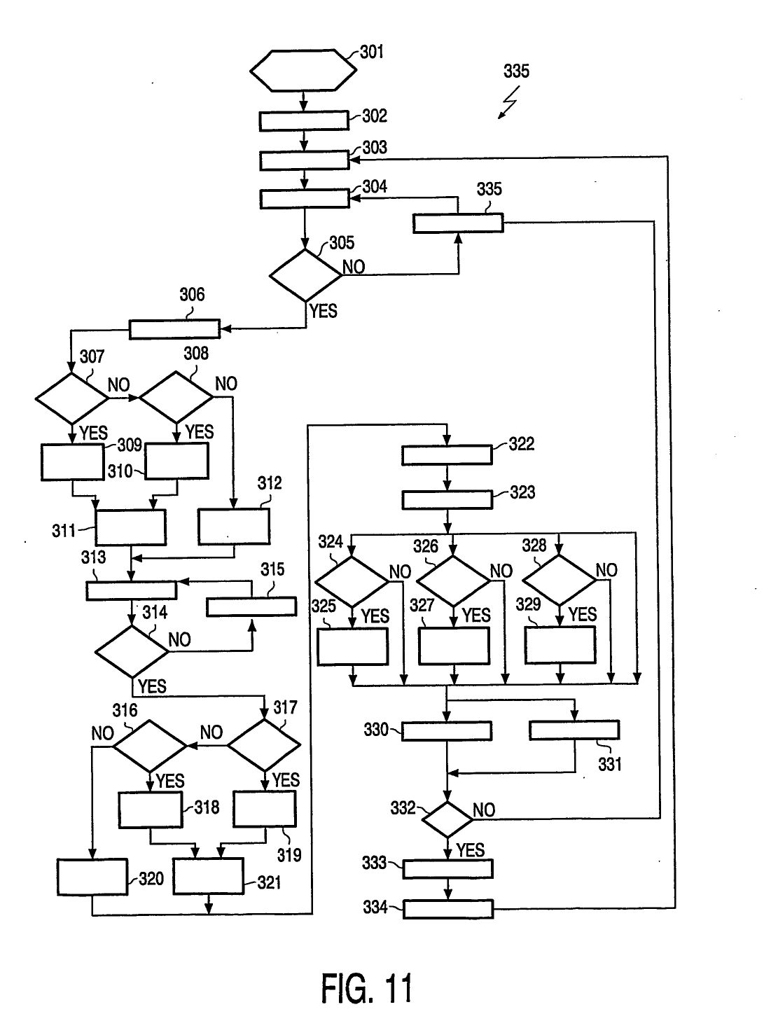

In the flowchart (FIG. 8), in step 203, the n-th line of the input video IV is extracted. Within a line, all text sequences (sequences of adjacent text pixels) are evaluated. In the following it is assumed that the whole input line is visible, so that all text sequences can be evaluated at once. The extension to the case of a limited analysis window is discussed with respect to the flowchart shown in FIG. 11.

In step 204, a next text sequence is detected. In step 205, the start and end positions s and e, respectively, and the length l=e−s+1 of the text sequence are computed. Then, in step 206, the desired output sequence length L is determined by equation (3).

If only this constraint for thickness preservation was applied, it could cause disconnections and misalignments within scaled characters. For example, consider the case wherein the input/output length mapping is performed by using equation (3) with 1k=0.6 and the scaling factor z=1.28. In this case the relation between input and output sequence length is:

| l | l · z | L = roundₖ(l · z) |
|---|---|---|
| 1 | 1.28 | 1 |
| 2 | 2.56 | 3 |
| 3 | 3.84 | 4 |
| 4 | 5.12 | 5 |
| 5 | 6.4 | 7 |
| 6 | 7.68 | 8 |
| 7 | 8.96 | 9 |

As a 3 pixel long sequence 1 is mapped to a 4 pixel long sequence L, given the position of the two vertical strokes as in FIG. 9A, it is impossible to place the output sequence without disconnecting its right (or left) extreme. On the contrary, if the position of the right vertical stroke is as shown in FIG. 9B, the upper right connection would be preserved but the right end of the 7 pixel long sequence would lose the vertical alignment thus producing a spurious pixel adjacent to the right side of the character.

In order to preserve connections and alignment it is necessary to allow some flexibility either on the position and/or the length of the output sequence. In this respect the value computed with equation (3) must be considered as a desired output sequence length L which, based on the configuration of the surrounding text pixels, may be slightly adapted.

The dimensions of the analysis window for analyzing this configuration depend on the available hardware resources. In the following we assume that the window spans three lines, from one above to one below the current line, and all pixels of each line. This allows to ‘see’ each input sequence as a whole, from start s to end e.

The idea for preserving connections and alignment of text pixels in the output map is to adjust the position of the start S and the end E of each output sequence by a displacement needed to place them in the appropriate position such that the output pixel is connected/aligned to the corresponding extreme in the previous output line, depending on the information on alignments found on the corresponding input sequence.

In this respect, with a three line high analysis window, it is possible to distinguish between various diagonal connections and vertical alignment patterns, both toward the previous line and the next line as shown in FIG. 10.

Alignments and connections toward the previous line (FIGS. 10A, C, E and G) are used for determining the alignment of the extremes of the current output sequence. For instance, if the situation shown in FIG. 10A is detected, we know that an upward vertical alignment of the starting point on the current output sequence must be met. Therefore, we search for the point Sp in the previous line of the output domain OPM corresponding to sp in the input domain IPM (the position of Sp is determined by the calculations of the previous line). The current output starting point S will then be set to the same position as Sp. A similar procedure is applied if a vertical alignment is detected at the ending point of the sequence. In case of a diagonal alignment, as shown in FIGS. 10E and G, the position of the current extreme is purely determined by the nearest neighbor scheme. As we will see later, this choice guarantees that diagonal connections are always preserved.

To determine the position of E we need to know:
the position of e in the input domain,
if a vertical alignment connection is present,
in case the previous point is true, the position of Ep.
   The last item in the list tells that the position of Ep has to be tracked in order to compute the position of E. For this purpose a binary register, called Current Alignment Register (CAR) is introduced. The CAR, which is as long as an output line, stores for each pixel position a binary value which is 1 if a vertical alignment must be met and 0 otherwise. Note that diagonal connections are not included in this register CAR

If in an input sequence it is found that its start s is vertically aligned, then the corresponding output position S will be the same as the vertical output position Sp in the previous line. This position is available in the CAR which contains a 1 exactly on the position Sp.

We first compute the output interval Iₛ which contains the positions corresponding to s:
Iₛ=[└(s−0.5)_{z}┘,┌(s+0.5)z┐] (4)
Then the register CAR is scanned within the interval Is until a 1 is found, which is thus Sp. The same procedure applies for a vertical alignment on the end Iₑ of a sequence
Iₑ=[└(e−0.5)z┘,┌(e+0.5)z┐] (5)

The CAR is valid for one line. When the processing moves to the next line, CAR must be updated in order to account for alignments concerning the new line. Actually, upward alignments of line i (which are stored in the CAR) are exactly the downward alignments of line i-1. We can therefore set the alignment flag for the next line by looking at the downward alignment of the current line, i.e. the configurations shown in FIGS. 10B and 10C. In practice it is appropriate to define another register, the Next Alignment Register (NAR), with the same dimension as CAR in which the alignment positions for the next line are stored. Each time an input sequence is mapped to the output domain, its ends are analyzed in order to see if a downward alignment occurs. If this is the case the corresponding position in NAR is set to 1. At the end of the processing of the line the register NAR contains the values of the register CAR to be used with the next line.

Summarizing, for each input text sequence the following operations will be performed:
analyze input text sequence ends s and e in relation to text pixels in the previous line (are the configurations shown in FIG. 10A or C detected?),
decide on the sequence position (S and E) in the output domain, possibly looking for alignment in the register CAR,
analyze input sequence ends in relation to text pixels in the next line (are the configurations shown in FIG. 10B or F detected?),
set a 1 at the start position S in the output pixel map OPM (or the end position E) in NAR if the configuration shown in FIG. 10B or F is recognized, and
at the end of the line, the register NAR is copied onto the register CAR and then reset.

The principle by which diagonal connections are preserved is to simply map the sequence extremes (s or e) by applying the nearest neighbor scheme, whenever a diagonal connection is detected, either upward or downward (the situations depicted in FIGS. 10E, F, G and H), regardless the presence of a vertical alignment. More in detail, if the starting point s of a sequence is within a diagonal connection pattern, the associated output extreme S is

$$S = ⌈ ( s - \frac{1}{2} ) \cdot z ⌉ \qquad ( 6 )$$

while if the ending point e has to be mapped the relation is

$$E = ⌊ ( e + \frac{1}{2} ) \cdot z ⌋ \qquad ( 7 )$$

Note that, unlike the processing of vertical alignments, for which only upward alignment were considered for the current line, the diagonal connection constraint is imposed both when up or down connections are detected. Moreover, a sequence extreme is subject to the nearest neighbor mapping whenever it is part of a diagonal connection, regardless the presence of vertical alignment. In other words, the preservation of diagonal connections has the priority over the vertical alignment constraint. In practice, if an upward alignment and a downward diagonal connection are verified together, the nearest neighbor mapping scheme is applied. By experiments, the choice of privileging diagonal connections showed to better preserve the general shape of characters.

In FIG. 8, the above elucidated algorithm is implemented for a start point in the steps 207 to 212, and for an end point in the same manner in the steps 213 to 218. In step 207, it is detected whether a diagonal connection is present, if yes, the start point S in the output map is calculated with equation (6) in step 209 and a flag S_set is set in step 211 indicating that the start point is fixed in position. If no diagonal connection is detected, in step 208 it is detected whether a vertical alignment is present. If yes, the position of the start point S in the output pixel map OPM is found in the register CAR as defined in step 210, and the flag S_set is set in step 211. If no vertical alignment is found, in step 212 the flag S_set is reset to indicate that the start point S is not fixed by a diagonal or vertical constraint.

The step 214 checks on a diagonal connection for an end point (which is the right hand extreme of a sequence of adjacent text labeled pixels). If yes, the end point E in the output pixel map OPM is calculated with equation (7) and the flag E_set indicating that the end point E is fixed is set in step 216. If no, in step 213 is checked whether a vertical alignment exists, if yes, the end point E is set in step 215 based on the register CAR and again the flag E_set is set in step 218, if no, in step 217 the flag E_set is reset to indicate that the end point E is not fixed by the diagonal and vertical alignment preservation.

Once the above alignment/connection steps are performed three situations are possible.
(i) Both extremes have been fixed by the constraints. In this case the position of the output sequence is completely determined, and the algorithm proceeds with step 225.
(ii) Only the start point S or the end point E has been fixed by the constraints. As one of the two extremes is freely adjustable, we can impose the condition that the output length is the desired length Ld as computed by equation (3).

Therefore, if in step 221 is detected that the starting point S has been fixed by the alignment constraint, and the end point B is not yet fixed, the endpoint E is determined in step 224 by the relation:
E=S+L_{d}−1 (8)

Similarly, if in step 220 is detected that the endpoint E has been fixed and the tart point S is not yet fixed, the start point S is computed in the step 223 as:
S=E−L_{d}+1 (9)
(iii) If is detected in step 219 that both extremes S and E are freely adjustable, besides the condition on output length L, it is possible to decide on the position of the sequence. Preferably, the line is centered by aligning the midpoints of the output sequence with the exact (not grid constrained) mapped one. The exact mapping of the two extremes is
s—S_{id}=s·z e→E_{id}=e·z (10)
and the related midpoint is

$${M}_{id} = \frac{{S}_{id} + {E}_{id}}{2} \qquad ( 11 )$$

In step 222, the values for the extremes S and E that best center the output sequence, while keeping the length equal to L_{d} is computed as:

$$\begin{matrix}\begin{matrix}S = 〈 {M}_{id} 〉 - \frac{{L}_{d} - 1}{2} \\ E = 〈 {M}_{id} 〉 + \frac{{L}_{d} - 1}{2}\end{matrix} \} if {L}_{d} is odd & ( 12 ) \\ \begin{matrix}S = ⌊ {M}_{id} ⌋ - \frac{{L}_{d}}{2} + 1 \\ E = ⌊ {M}_{id} ⌋ + \frac{{L}_{d}}{2}\end{matrix} \} if {L}_{d} is even & ( 12 )\end{matrix}$$

In FIG. 8 the steps 219 to 224 perform the above part of the algorithm. In step 219 is determined whether both the start point S and the end point E are not fixed in position by a constraint, if yes, the line is centered in step 222 using equation (12). In step 220 is tested whether the start point S is not fixed but the end point E is. If yes, the start point S is calculated with equation (9). In step 221 is tested whether the start point S is fixed and the end point E is not fixed. If yes, the end point B is calculated in step 224 with equation (8).

Next, in step 225, the register NAR is updated and in step 227 is checked whether the end of the line is reached. If not, the algorithm proceeds with step 204. If yes, the register NAR is copied into the register CAR in step 228, the line number is increased by one in step 229, and the algorithm proceeds with step 203. The adaptive interpolation step which will be discussed later, is indicated by step 226.

In summary, the flowchart 8 describes an embodiment for the output text map OPM construction. For each input sequence the position of the start point s and the end point e are first determined. Then the desired output length L_{d} is computed. At this point the two sequence ends are analyzed separately, looking for diagonal connections or vertical alignment (Sequence Alignment Analysis). Note that if a diagonal connection is detected, the vertical alignment processing is skipped. For both extremes a Boolean variable (S_set and E_set) is defined. This variable is set if the related extreme has been fixed by the constraints, and reset in the opposite case. Based on this information the output sequence is positioned (Output sequence positioning). Possible situations are:
S_set=0 and E_set=0. In this case, both starting and ending point are not fixed. Output sequence is positioned by equation (12).
S_set=0 and E_set=1. The starting point of the output sequence is determined by (9)
S_set=1 and E_set-0. The ending point of the output sequence is determined by (8) S_set=1 and E_set=1. The output sequence is already fixed.

Once the positions of S and E have been computed, a further check on the input configuration is performed. If e (or s) exhibits a downward vertical alignment position E (or S) in NAR is set to 1. At this stage, all elements needed for the actual image interpolation are ready and the adaptive interpolation (anti-aliasing) step 226 can be performed.

In the above described algorithm, the whole sequence to be mapped was visible at once which means that it is possible to map an arbitrarily long sequence in a video line, but that the whole line of labeled input pixels has to be stored.

This is not necessary if position/configuration registers are introduced. For example, it is possible to analyze a 3×3 window around each input pixel of the input video IV to find out if it is part of a 0→1 or 1→0 transition. In the first case (a sequence start) the current position s can be stored into an internal position register, along with the information on vertical alignment and diagonal connections (the configurations shown in FIG. 10A to F). When the subsequent 1→0 transition is detected at position e, all information (alignment/connection of extremes and input sequence length) is available to map the whole input sequence to the output domain by following the procedure explained in the previous sections, thus preserving both the length and alignment/connection constraints. Of course, this solution implicitly assumes that the whole output line is accessible, as the length of the input sequence (and therefore the length of the corresponding output) is limited only by the line length.

In principle, with this last and preferred approach the overall behavior is exactly the same as the one described with no resource limitations. The preferred algorithm for the mapping step is depicted in the flowchart of FIG. 11 which is obtained by the flowchart of FIG. 8 by serialization of the sequence start processing and the sequence end processing.

FIG. 11 shows a flowchart of an embodiment of the output text map construction in accordance with the invention.

In step 302 it is detected which input pixels in the input video IV in step 301 are input text pixels ITP. In step 303 the input pixel 0 of the line n of the input video IV is received. In step 335 a counter increments an index i with 1, and in step 304, the input pixel with index i (the position i the tine in the input pixel map IPM) is selected in the algorithm.

In step 305 is checked whether the input pixel i of line n is a text sequence start or not. If not, the index i is increased in step 335 and the next pixel is evaluated. If yes, the start position and its neighbor configuration is stored in step 306. The steps 307 to 312 are identical to the steps 207 to 212 of FIG. 8 and determine whether a diagonal or vertical alignment has to be preserved for the start pixel. In step 307 is checked on a diagonal connection, in step 308 is checked on a vertical alignment. In step 309 the start point S is determined by the nearest neighbor, and in step 310 the end point S is determined by using the information in the register CAR. If the start point S is not fixed, in step 312 the flag S-set is reset to zero. If the start point S is fixed the flag S-set is set to one in step 311.

After the value of the flag S_set has been determined, i is increased by one in step 313, and of the next pixel is checked in step 314 whether it is an end pixel. If not, i is incremented in step 315 and the next pixel is evaluated by step 314. If in the step 314 a sequence end is detected, the steps 316 to 321 are performed which are identical to the steps 213 to 218 of FIG. 8 and which determine whether a diagonal or vertical alignment has to be preserved for the end pixel. Step 316 checks on vertical alignment, step 317 on a diagonal connection, in step 318 the end point E is set by using the information in the register CAR, and the end point E is set by the nearest neighbor in step 319. Step 320 resets the E_set flag, and step 321 sets the E_set flag.

In step 322, the input sequence length l is determined, and in step 323, the output sequence length L_{d} is calculated.

The steps 324 to 334 are identical to the steps 219 to 229 of FIG. 8. In Step 324 is checked whether S_set=0 and E_set=0, and if true, the output sequence is centered in step 325. In Step 326 is checked whether S_set=0 and E_set1, and if true, the start point S is determined by equation (9) in step 327. In Step 328 is checked whether S_set=1 and E_set=0, and if true, the end point E is determined by the equation (8) in step 329.

The register NAR is updated in step 330 and the adaptive interpolation is performed by step 331. If in step 332 not an end of line is detected, i is incremented to fetch the next input sample in step 304. If in step 332 an end of line is detected, the register NAR is copied into the register CAR in step 333 and the index n is increased by one in step 334 to extract the next video line in step 303.

The required memory resources are now: a sliding 3×3 window on the input image and three binary buffers as long as the output line: CAR, NAR and the current output text map line.

In an embodiment of the detection mapping procedure, the output area to store samples is smaller than the whole line. Assuming that CMAX is the maximum output sequence length, the corresponding maximum input sequence length c_{MAX} is
c_{MAX}=┌C_{MAX}/z┐.
Whenever the output sequence length C is greater than CMAX (output sequence length C>CMAX) it is not possible to map the two output ends simultaneously as they are too far apart. Even though the output length cannot be preserved, connections can still be maintained. For each input pixel it is still possible to see a region around it (the analysis window) spanning CMAX+2 columns and three lines. Compared to the initial assumptions, we restrict the visibility from the whole input line to CMAX+2 columns. If an input pixel is in the middle row at the second column of the analysis window it is possible to detect 0→1 transitions which are text sequence starts. Similarly, a sequence end will be the next to last position (column CMAX+1) when a transition from 1+0 occurs.

The algorithms described until now, map a sequence whenever it is entirely visible, which is the case only if the sequence length is equal or less than CMAX. If only part of the sequence is visible, for each incoming pixel the following algorithm may be performed:
If no text pixels are contained by the analysis window, no actions are taken.
If the current pixel is a sequence start, and the end of the sequence is within the analysis window, the whole sequence is within the analysis window. The mapping is then identical as explained in the above described algorithms.
If only the start of the sequence is visible, the start point s is mapped to the output grid by following the rules on alignment/connections, and the end point e is mapped by equation (6).
If only text pixels are included in the middle line of the analysis window, both the start point s and the end point e are mapped by the nearest neighbor equations (6) and (7), respectively.

If only the end of the sequence is visible, the start point s is mapped by equation (6), while the end point e is mapped by the alignment/connection constraints.

Note that as each input pixel arrives, the output reference area is moved forward and partially overlaps the previous one. As a consequence, the output sequence is built progressively. The two extremes are explicitly mapped by following the alignment/connection rules, while the length L of the sequence is a consequence of the sliding window process, which, as stated at the beginning of the section, allows preserving the alignments and the desired length up to CMAX.

The mapping 110 (also referred to as output text map constructor) is a scaling algorithm for binary text images which tends to reduce artifacts that are typical of pixel based schemes, namely the pixel repetition. In order to further reduce the residual geometrical distortions and to have a controllable compromise between sharpness and regularity, an interpolation stage 112 (also referred to as interpolator) is introduced based on a non linear adaptive filter. The interpolation stage 112 is controlled by the mapping step 110 via the adaptive warper 111 to introduce gray levels depending on the local morphology (text pixel configuration) so that diagonal and curved parts are smoothed much more than horizontal and vertical strokes (that are always sharp and regular, as the output domain is characterized by a rectangular sampling grid).

Another important feature is that the global sharpness control 113 allows adjusting the general anti-aliasing effect with a single general control to change from a perfectly sharp result (basically the output map with no gray levels around) to a classical linearly interpolated image. The particular non linear scheme adopted (the Warped Distance, or WaDi, filter control) allows to use whichever kernel (bilinear, cubic, etc.) as a basis for computations. In this way, the general control ranges from a perfectly sharp image to an arbitrary linear interpolation. In this sense, the proposed algorithm is a generalization of the linear interpolation.

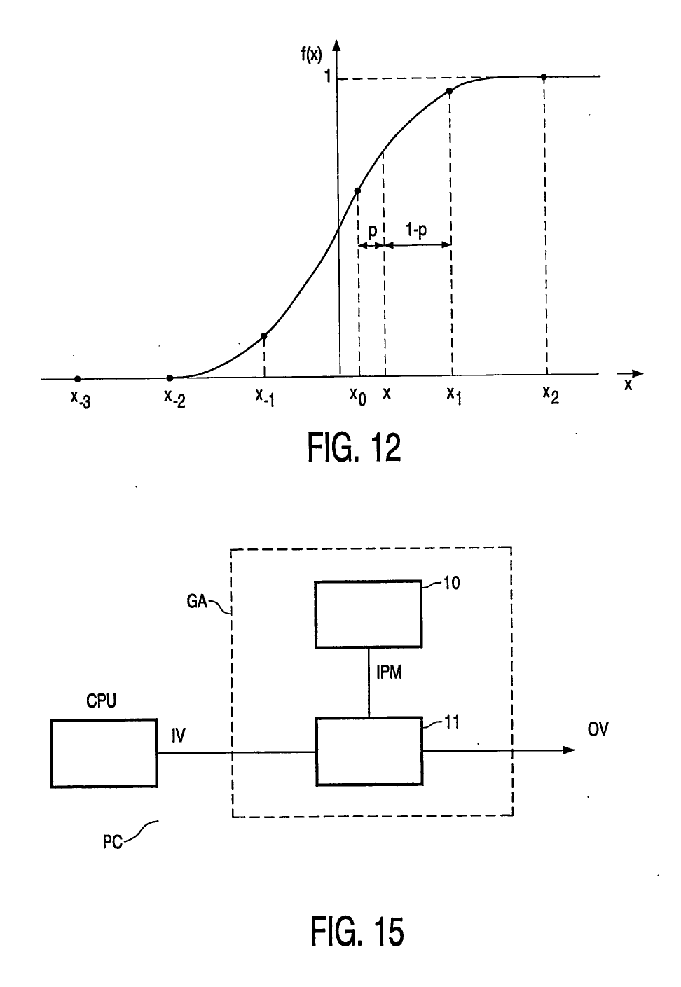

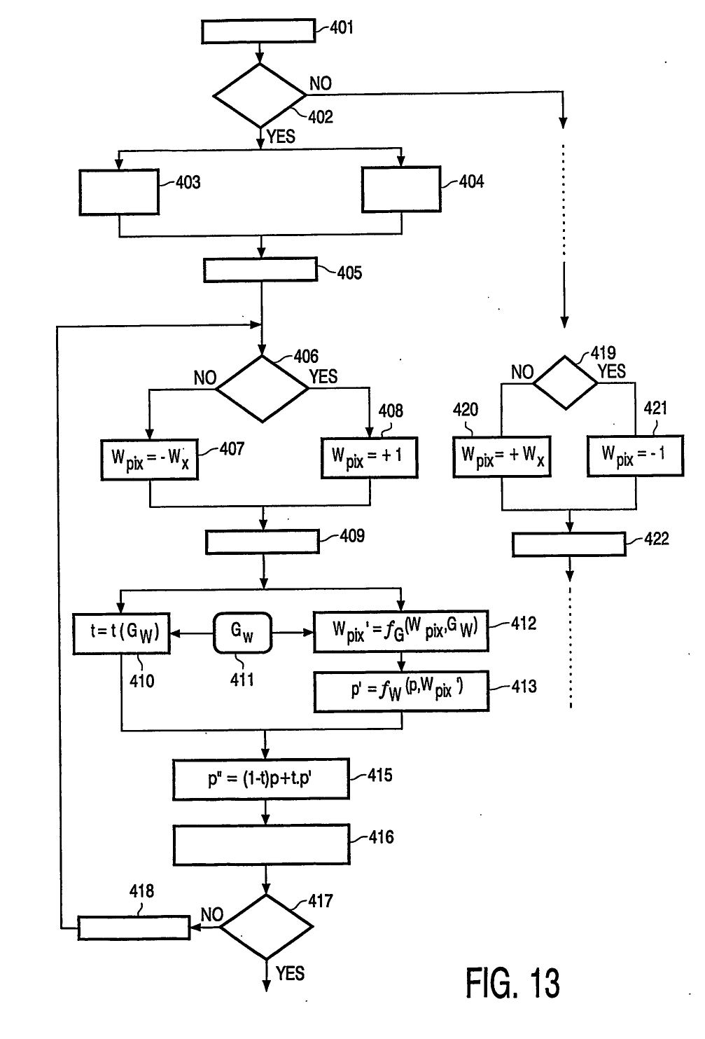

In the following, first the general theory behind the Warped Distance interpolator 112 will be elucidated with respect to FIG. 12. The control of the WaDi by the output text mask OTM, obtained by the mapping step 110, is elucidated with respect to the flowchart shown in FIG. 13.

FIG. 12 shows a waveform and input samples for elucidating the known Warped Distance (WaDi) concept. The function f(x) shows an example of a transition in the input video signal IV.

The known concept Warped Distance for linear interpolators adapts a linear interpolator to the local pixel configuration of natural (non graphic) images. Particularly, the aim was to prevent edges from being blurred by the interpolation process. If the output pixel to be interpolated is in a position u in the output map OPM, the corresponding position of the output pixel in the input domain (IPM) is x=u/z, wherein z is the scaling factor. The phase p=x−x0, wherein x0 is the left hand input sample next to x. If a simple tent (bilinear) kernel is applied as the base kernel, the output value would be:
\hat{f}(x)=(1−p)f(x₀)+pf(x₁) (13)
wherein x1 is the right hand input sample next to x.

Generally speaking, the interpolated sample is a linear combination of the neighboring pixels, which linear combination depends on the fractional position (or phase) p. The interpolating at a luminance edge is adapted by locally warping the phase, such that x is virtually moved toward the right or left input pixel. This warping is stronger in presence of luminance edges and lighter on smooth parts. In order to determine the amount of warping, the four pixels around the one that has to be interpolated are analyzed, and an asymmetry value is computed:

$$A = \frac{\vert f ( {x}_{1} ) - f ( {x}_{- 1} ) \vert - \vert f ( {x}_{2} ) - f ( {x}_{0} ) \vert}{L - 1} \qquad ( 14 )$$

wherein L is the number of allowed luminance levels (256 in case of 8-bit quantization). And x₁ is the input sample preceding the input sample x₀, and x₂ is the input sample succeeding the input sample x₁. Provided the sigmoidal edge model applies, the asymmetry value in (14) is 0 when the edge is perfectly symmetric, and 1 (or −1) when the edge is more flat in the right (left) side.

The sample to be interpolated should be moved towards the flat area it belongs to. Therefore, when A>0 the phase p has to be increased, while if A<0 the phase p has to be decreased. This is obtained by the following warping function:
p′=p−kAp(p−1) (15)
where k is the general amount of warping. The warped phase p′ remains in the range [0,1], if k is in the range [0,1]. It has to be noted that the two extremes p=0 and p=1 are maintained (p′=0 and p′=1, respectively), regardless the value of A and k. This means that if the base kernel is an interpolator (if the interpolated signal is equal to the input signal if x matches exactly one of the positions of an input sample) the warped kernel is still an interpolator.

In an embodiment in accordance with the invention, the concept of the phase warping is used to control the amount of anti-alias (gray levels around characters). Compared to the known WaDi, the warping function for text scaling is completely redesigned, in order to account for text morphology. Furthermore, the general control k of equation (15) is replaced by a more complex control which allows to range from a linearly scaled image to a completely binary one.

FIG. 13 shows a flowchart elucidating the operation of the WaDi controller 112 in accordance with an embodiment of the invention. The WaDi controller 112 determines the amount of warping that has to be applied to each output pixel phase p. In order to compute the new phase p, for each sample the following contributions are considered.
the classification of the output pixel to be computed (text or background), this information is provided directly by the mapper 110.
the morphological constraints, the pattern of text pixels around the current one determines the local anti-aliasing effect. For instance, if the current pixel is part of a diagonal line, the warping is less emphasized than the case of a pixel belonging to a horizontal or vertical straight line.
the required general amount of anti-aliasing, this is an external user control. The two extremes are the base kernel and the perfectly sharp interpolation (basically the binary interpolation obtained by the mapping step). Intermediate values of this control are not just a pure blending of the two extremes, but rather a progressive and differentiated adaptation of the anti-aliasing level of the various pixel configurations considered by the previous step.

The warping process is only required around text edges, thus at the start and the end of text sequences because the inner part is mono-color (constant) and whichever interpolating kernel would produce the same (constant) result. Therefore, with no loss in generality we can assume that the phase p is left unchanged in the inner part of text sequences and within the background. The extremes are detected in step 401.

From an algorithmic point of view, we apply the WaDi control only when in the input text map a transition 0→1 (text sequence start s) and 1→0 (text sequence end e) are detected. This detection is inherently performed by the mapping step 110. Therefore we can insert the adaptive interpolation step 112 right into the mapping stage (just before the NAR update in the flowchart of FIG. 8).

If in step 402 a start s or an end e of a sequence is detected, the appropriate one of the two branches of the flowchart is selected. The operations are basically the same and only some parameter settings related to the morphological control are different, see the steps 406 to 409 and the steps 419 to 422. In the following only the start of a sequence is elucidated.

After the start s of a sequence has been detected in step 402, in step 403 it is determined which output pixels are involved by the 0→1 transition in the input map IPM. The phase for these pixels only will be computed by the WaDi controller 112. Thus included in the calculations are all pixels found within the output transition interval
I_{w}=[┌(s−1)z┐, ┌s·z┐] (16)
In case of a tent (bilinear) kernel, output pixels outside the output transition interval Iw are of no interest since the two neighboring input pixels in the input map IPM (whose position is greater than s or less than s-1) have the same label (0 or 1) and will therefore produce the same result, regardless the phase value p. In the general case of a kernel of length Lₕ, such as the cubic whose extension is four pixels, equation (16) is only a approximation and must be adapted in order to contain the whole step response:
I_{w}=[┌(s−Lₕ/2)z┐,└s·z┘] (17)

By way of example, and for the sake of simplicity a bilinear base kernel is elucidated, the extension to longer kernels being straightforward.

By way of example, the morphological control is based on the analysis of a 3×2 window around the current input pixel (s or e, as detected by the mapping step). The analysis window is searched for a match in a small database containing all possible configurations grouped in six categories:
Isolated starting (ending) pixel. This configuration is typical of many horizontal strokes found for instance in small sized sans-serif characters such as 10 point arial ‘T’.
Vertically aligned pixels. These are typical of vertical strokes.
The pixel is part of a thin diagonal stroke.
The pixel is likely to be part of a thick diagonal stroke or a curve.
The pixel could be part of a thicker diagonal stroke but could be also part of an intersection between a horizontal and a vertical line.
The pixel is within a concavity.

The determination of the input transition configuration is performed in step 404. In step 405, the leftmost pixel in the output transition interval I_{W} is fetched.

A major difference between the algorithm controlling the WaDi in accordance with an embodiment of the invention and the known algorithm for natural images is that beside the amount, of warping, in the embodiment of the invention its direction or sign is defined. This allows driving the warping toward the left or right interpolation sample (x0 or x1, respectively, in FIG. 12) based on the text/background classification. The warping factor Wₚᵢₓ quantifies the amount and direction of the phase p′ (absolute value and sign respectively) which for the current pixel is defined as:

$$\begin{matrix}{p}^{′} = {f}_{w} ( p , {W}_{pix} ) \\ = \{ \begin{matrix}- {W}_{pix} {p}^{2} & - 1 \leq {W}_{pix} < 0 \\ p & {W}_{pix} = 0 \\ ( {W}_{pix} - 1 ) {p}^{2} + 2 ( 1 - {W}_{pix} ) p + {W}_{pix} & 0 < {W}_{pix} \leq 1\end{matrix}\end{matrix} \qquad ( 18 )$$

Beside the above features, the definition of the warping function also allows the control of the minimum possible displacement. For instance, if the warping Wₚᵢₓ=0.3 and p=0 (the current output pixel coincides exactly with an input pixel) p′=0.3, which means that the output pixel is moved rightward of at least 0.3 pixels, regardless its original phase.

Another property of the warping function is due to the fact that it is a quadratic function of p. When the factor Wₚᵢₓ is positive (or negative) and p is near the origin (near 1) the warping effect is stronger, meaning that output pixels that are near input samples are ‘attracted’ more than pixels that are halfway.

The morphological control is achieved by assigning a specific warping factor Wₚᵢₓ to each output pixel. Assuming that the input transition is a start transition (the same holds in an analogous manner for an end transition), for each pixel in the output transition interval I_{w} the warping factor Wₚᵢₓ is selected as follows:
If in step 406 is detected that the pixel has been marked as text by the mapping 110, then in step 408 the value of the warping factor is set to Wₚᵢₓ=1. This setting is equivalent to assign the right hand input value (which is text) to the current output sample. The aim is that output pixels that are marked as text should preserve the same color as the original image.

If in step 406 is detected that the pixel has been marked as background, then, in step 407, the factor Wpix becomes −Wx, wherein Wx is a constant specific to the configuration detected by the morphological analysis in step 404. As an example, a possible definition of the constant Wx is the following:

| configuration of pixels in | | | | |
|---|---|---|---|---|
| the 3 * 2 window (1 is text) | | | | value of Wx |
| 00 | | | | 0.8 |
| 01 | | | | |
| 00 | | | | |
| 00 | 01 | 01 | | 0.85 |
| 01 | 01 | 01 | | |
| 01 | 00 | 01 | | |
| 00 | 01 | 10 | 10 | 0.3 |
| 01 | 01 | 01 | 01 | |
| 10 | 10 | 00 | 01 | |
| 00 | 11 | | | 0.15 |
| 01 | 01 | | | |
| 11 | 00 | | | |
| 01 | 11 | | | 0.1 |
| 01 | 01 | | | |
| 11 | 01 | | | |
| 10 | 11 | 10 | 11 | 0.8 |
| 01 | 01 | 01 | 01 | |
| 10 | 11 | 11 | 10 | |

In case of a sequence start, the factor Wₚᵢₓ becomes negative (Wₚᵢₓ=−Wx) in step 407 if the output pixel has been marked as background, and the factor Wₚᵢₓ becomes positive (Wₚᵢₓ=Wx) in step 408 if it has been marked as text. This means that background pixels are moved leftward and text pixels are moved rightward.

In step 409 the phase p is computed. Higher distortion values correspond to sharper results. Therefore, configurations related to diagonal patterns, are smoothed, as the warping factor is low. On the other hand, configurations that are likely to be part of a horizontal or vertical stroke, are strongly warped toward the background, thus emphasizing the contrast to the text.

The global control stage 113 (the steps 410 to 413 and 415) adjusts the general amount of anti-aliasing. As an example, the control stage 113 is able to set the anti-alias level from the base kernel (maximum anti-alias) to the perfectly sharp image (no gray levels around text) by modulating the phase warping computed in the morphological control step. For example, by using a single parameter GW, ranging in the interval [0,2], the behavioral constraints for the global warping control are:
Gw=0→No warping effect. The input video (IV) is processed by the pure base kernel.
Gw=1→Warping is defined by the morphological control.
Gw=2→No gray levels around text. The resulting image is determined by directly using the output text map and replacing the text/background labels with the text/background color.
On order to fir all the three constraints, the factor Wₚᵢₓ is replaced by the factor Wₚᵢₓ′ which for example is the piecewise linear relation (step 412):

$$\begin{matrix}{W}_{pix}^{′} = {f}_{G} ( {W}_{pix} , {G}_{W} ) \\ = \{ \begin{matrix}{W}_{pix} {G}_{W} & 0 \leq {G}_{W} \leq 1 \\ ( 1 - {W}_{pix} ) {G}_{W} + 2 {W}_{pix} - 1 & 1 < {G}_{W} \leq 2\end{matrix}\end{matrix} \qquad ( 19 )$$

The factor Wₚᵢₓ′ has the same sign as the factor Wₚᵢₓ and consequently the warping direction is not changed. An interesting property of equation (19) is that the slope changes for G_{w}<1 and G_{w}>1. The slope in the first part is proportional to the factor Wₚᵢₓ, while it is proportional to 1−Wₚᵢₓ, in the second part (G_{w}>1). Therefore, for high values of the factor Wₚᵢₓ most of the sharpening effect occurs in the range 0<G_{w}<1, while for lower values of the factor Wₚᵢₓ (<0.5) most of the effect takes place for the parameter G_{w}>1. As the factor Wₚᵢₓ depends on the local morphology, the result is that different parts of characters will be sharpened differently when G_{w} changes. Step 411 controls the value of G_{w}.

If the factor Wₚᵢₓ is small, the warping function (18) tends to behave like an identity (p′=p). By definition the warping function is quadratic, even when the factor Wₚᵢₓ is near zero. Therefore the phase is still warped (p′< >p) except when p=0 or p=1. In order to overcome this drawback, a blending function is introduced which weights the original phase much more than the warped phase for values of G_{w} which approach zero:
p″=[1−t(G_{w})]p+t(G_{w})p′ (20)
wherein

$$t ( {G}_{W} ) = \{ \begin{matrix}{log}_{10} [ 9 ( - {G}_{W}^{2} + 2 {G}_{W} ) + 1 ] & {G}_{W} ∈ [ 0 , 1 ) \\ 1 & {G}_{W} ∈ [ 1 , 2 ]\end{matrix} . \qquad ( 21 )$$

The function t(G_{w}) is calculated in the step 410, the warping factor Wₚᵢₓ is determined in step 412 with equation (19), the value of the phase p′ is determined in step 413 by using the equation (18), and the phase p′ is determined in step 415 in accordance with equation (21). Note that equation (21) is only an example of a weighting function for correcting warped phase values for low values of G_{w}. In an preferred embodiment, the interpolator 112 is controlled by the warped phase WP (as indicated in FIG. 7) to obtain the phase p″. If the global control 113 is not required, the interpolator 112 is controlled with the phase p computed by the step 409.

In step 416, the output luminance is calculated by the linear combination of input pixels by using the new phase p″. In step 417 is tested whether the current pixel is the last one in output transition interval I_{w}, if no, the computations for the current output transition interval I_{w} continues in step 406 for the next pixel. The next pixel is fetched in step 418.

A same algorithm is performed when an end of the sequence is detected in step 402. The only difference is that the steps 406 to 409 are replaced by the steps 419 to 422.

If in step 419 is detected that the pixel has been marked as text by the mapping 110, then in step 421 the value of the warping factor is set to Wₚᵢₓ=−1. This setting is equivalent to assign the left hand input value (which is text) to the current output sample. The aim is that output pixels that are marked as text should preserve the same color as the original image. If in step 419 is detected that the pixel has been marked as background, then, in step 420, the factor Wₚᵢₓ becomes Wx, wherein Wx is a constant specific to the configuration detected by the morphological analysis in step 404. In step 422 the phase p is computed.

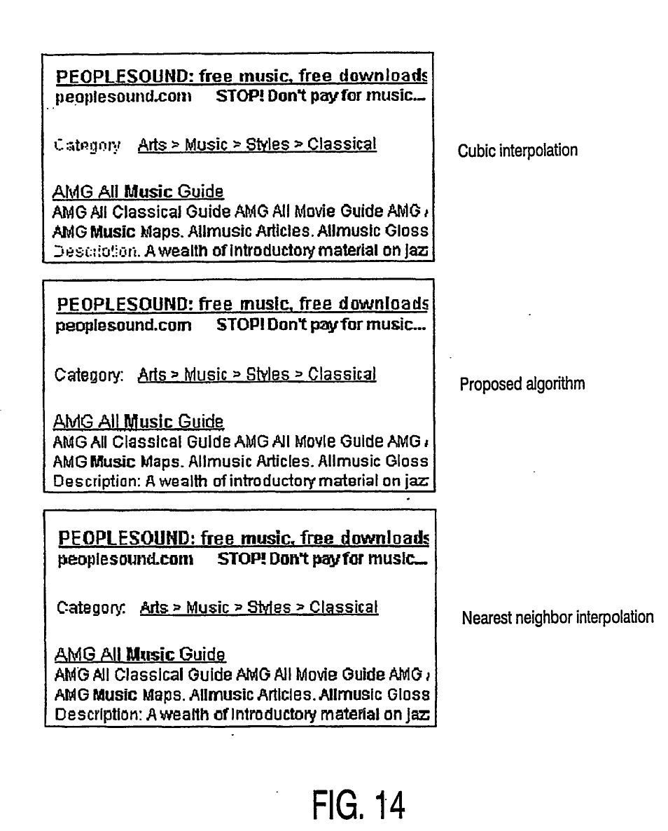

FIG. 14 shows from top to bottom, a scaled text obtained with a cubic interpolation, an embodiment in accordance with the invention, and the nearest neighbor interpolation. The improvement provided by the embodiment in accordance with the invention is clearly demonstrated.

FIG. 15 shows a block diagram of a video generator PC which comprises a central processing unit CPU and a video adapter GA which supplies an output video signal OV to be displayed on a display screen of a display apparatus. The video adapter GA comprises a converter for converting an input video signal IV with an input resolution into the output video signal OV with an output resolution, the converter comprises a labeler 10 for labeling input pixels of the input video signal IV being text as input text pixels ITP to obtain an input pixel map IPM indicating which input pixel is an input text pixel ITP, and a scaler 11 for scaling the input video signal IV to supply the output video signal OV, an amount of scaling depending on whether the input pixel is labeled as input text pixel ITP.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of converting an input video signal with an input resolution into an output video signal with an output resolution, the method comprising
labeling input pixels of the input video signal being text as input text pixels to obtain an input pixel map indicating which input pixel is an input text pixel, and
scaling the input video signal to supply the output video signal, the scaling being dependent on whether the input pixel is labeled as input text pixel.

2. A method as claimed in claim 1, wherein the method further comprises mapping the labeled input pixels forming the input pixel map onto an output pixel map indicating which output pixel in the output pixel map is text, the mapping being based on
(i) a scaling factor (z) defined by a division of the output resolution by the input resolution,
(ii) a position (s) of the input text pixel in the input pixel map, and
(iii) a geometrical pattern formed by the input text pixel with surrounding input text pixels, and wherein interpolating of the input video signal is controlled by the output pixel map.

3. A method as claimed in claim 2, wherein the mapping comprises
detecting, in a video line of the input video signal, the position being a start input position (s) in the input pixel map of a start input pixel of a line of successive input text pixels, and
determining whether in a previous video line of the input video signal an input text pixel is diagonally connected to the start input pixel, and if yes,
calculate an output position (S) in the output pixel map of a start output pixel corresponding to the start input pixel as a nearest larger integer of (the start input position-½)*the scaling factor.

4. A method as claimed in claim 2, wherein the mapping comprises
detecting the position being a start input position (s) in the input pixel map of a start input pixel of a line of successive input text pixels, and
determining whether in a previous video line of the input video signal an input text pixel is present at a same start input position (sp) as the start input position (s) of the start input pixel, and if yes
positioning in the output pixel map a start output pixel corresponding to the start input pixel at a same start output position (S) as the start output pixel corresponding to the input text pixel of the previous video line.

5. A method as claimed in claim 2, wherein the mapping comprises
determining in the input pixel map an input length (l) of a line of successive input text pixels, and
calculating an output length (L) of a corresponding line of successive output text pixels as an integer of the multiplication of the input length (l) and the scaling factor (z).

6. A method as claimed in claim 5, wherein the calculating is adapted calculate the output length (L) of the line of successive output text pixels as
L=nearest smaller integer of (l*z+k)
wherein l is the input length, z is the scaling factor and k is a number between 0 and 1.

7. A method as claimed in claim 2, wherein the mapping comprises detecting the position (s) being a start input position (s) in the input map of a start input pixel of a line of successive input text pixels,
determining whether in a previous video line of the input video signal an input text pixel is diagonally connected to the start input pixel, and if yes,
calculate a position in the output pixel map of a start output pixel corresponding to the start input pixel as a nearest larger integer of (the start input position-½)*the scaling factor, and if no,
determining whether in a previous video line of the input video signal an input text pixel is present at a same start input position as the start input position of the start input pixel, and if yes
positioning in the output pixel map a start output pixel corresponding to the start input pixel at a same start output position (S) as the start output pixel corresponding to the input text pixel of the previous video line.

8. A method as claimed in claim 7, wherein the mapping further comprises
detecting an end input position in the input pixel map of an end input pixel of the line of successive input text pixels,
determining whether in a previous video line of the input video signal an input text pixel is diagonally connected to the end input pixel, and if yes,
calculating an end output position in the output pixel map of an end output pixel corresponding to the end input pixel as a nearest smaller integer of (the start input position-½)*the scaling factor (z), and if no,
determining whether in a previous video line of the input video signal an input text pixel is present at a same end input position as the end input position of the end input pixel, and if yes
positioning in the output pixel map an end output pixel corresponding to the end input pixel at the end output position as the end output pixel corresponding to the input text pixel of the previous video line.

9. A method as claimed in claim 8, wherein the mapping further comprises
(i) if the start output position of the start output text pixel of the line of successive input text pixels is fixed by the steps performed in claim 7, and the end output position of the end output pixel of successive input text pixels is fixed by the steps performed in claim 8, positioning in the output pixel map a line of successive output text pixels from the start output position to the end output position,
(ii) if the start output position is fixed by the steps performed in claim 7 and the end output position is not fixed by the steps performed in claim 8,
determining in the input pixel map an input length of the line of successive input text pixels, and
calculating an output length (L) of a corresponding line of successive output text pixels as an integer of the multiplication of the input length (l) with the scaling factor (z),
calculating the end output pixel as the start output pixel plus the output length (L),
(iii) if the start output text pixel of the line is not fixed by the steps performed in claim 7 and the end output pixel is fixed by the steps performed in claim 8,
determining in the input pixel map an input length (l) of a line of successive input text pixels, and
calculating an output length (L) of a corresponding line of successive output text pixels as an integer of the multiplication of the input length (l) and the scaling factor (z),
calculating the start output pixel as the end output pixel minus the output length (L) plus 1.

10. A method as claimed in claim 9, wherein the mapping further comprises centering the line of output text pixels if both the start output text pixel and the end output text pixel are not fixed by the steps of claims 7 and 8.

11. A method as claimed in claim 2, wherein the scaling comprises replacing the output pixels of the output pixel map by a value of a corresponding input video sample of the input video signal to obtain output video samples forming the output video signal.

12. A method as claimed in claim 2, wherein the scaling comprises interpolating a value of an output video sample based on a fractional position (p) between adjacent input video samples, and adapting the fractional position (p) based on whether a predetermined output pixel corresponding to the output video sample is text or not.

13. A method as claimed in claim 12, wherein the adapting of the fractional position (p) is further based on a pattern formed by output pixels surrounding the predetenmined output pixel, wherein the pattern is determined by the output pixels being labeled as text or non text.

14. A method as claimed in claim 12, wherein the scaling comprises determining transition output pixels involved in a transition from non-text to text, to perform the adapting of the fractional portion (p) only for output pixels at edges of text.

15. A method as claimed in claim 14, wherein
(i) if a predetermined one of the transition output pixels is labeled as text, adapting the fractional position (p) to control the interpolating to supply an output video sample being an input video sample at a position succeeding the output video sample, the succeeding input video sample being a text sample, and
(ii) if the predetermined one of the transition output pixels is labeled as non text, adapting the fractional position (p) to control the interpolating to supply an output video sample being an input video sample at a position preceding the output video, the preceding input video sample pixel being a non-text sample, and
(iii) adapting the fractional portion (p) based on a pattern formed by output text pixels surrounding the predetermined transition output pixel, wherein the amount of adapting is larger for a horizontal and vertical structure in the pattern than for a diagonal structure in the pattern.

16. A method as claimed in claim 15, wherein the scaling comprises a user controllable input for controlling an amount of the adapting of the fractional portion (p).

17. A converter for converting an input video signal with an input resolution into an output video signal with an output resolution, the converter comprises
a means for labeling input pixels of the input video signal being text as input text pixels to obtain an input pixel map indicating which input pixel is an input text pixel, and
a means for scaling the input video signal to supply the output video signal, an amount of scaling depending on whether the input pixel is labeled as input text pixel.

18. A display apparatus comprising a converter for converting an input video signal with an input resolution into an output video signal with an output resolution, the converter comprises
a means for labeling input pixels of the input video signal being text as input text pixels to obtain an input pixel map indicating which input pixel is an input text pixel
a means for scaling the input video signal to supply the output video signal, an amount of scaling depending on whether the input pixel is labeled as input text pixel, and
a matrix display device for displaying the output video signal.

19. A video signal generator comprising a central processing unit and a video adapter for supplying an output video signal to be displayed, the video adapter comprising a converter for converting an input video signal with an input resolution into the output video signal with an output resolution, the converter comprising
a means for labeling input pixels of the input video signal being text as input text pixels to obtain an input pixel map indicating which input pixel is an input text pixel, and
a means for scaling the input video signal to supply the output video signal, an amount of scaling depending on whether the input pixel is labeled as input text pixel.
